(19) United States
(12) Patent Application Publication
(10) Pub. No.: US 2005/0030754 A1
(43) Pub. Date: Feb. 10, 2005

(54) Systems, devices, and methods for mounting a light emitting diode

(76) Inventor: Harold Jay Licht, Johnson City, TN (US)

Correspondence Address: Siemens Corporation;Intellectual Property Department, 170 Wood Avenue South, Iselin, NJ, 08830, US

(21) Appl. No.: 10/691,780

(22) Filed: Oct. 23, 2003

Related U.S. Application Data
(60) Provisional application No. 60/493,311, filed on Aug. 7, 2003.

(51) Int. Cl. F21V 17/06

(52) U.S. Cl. 362/433

(57) ABSTRACT

Certain exemplary embodiments comprise a system for mounting an LED. The system can comprise a mounting device and a first bracket coupleable to a surface of the mounting device. The first bracket can be releasably and/or clampably attachable to a first electrically substantially conductive lead of an LED. The first electrically substantially conductive lead can extend substantially in a radial plane of the LED.

### CROSS-REFERENCES TO RELATED APPLICATIONS

This application claims priority to, and incorporates by reference herein in its entirety, pending U.S. Provisional Patent Application Ser. No. 60/493,311 (Attorney Docket No. 2003P11954US), filed 7 Aug. 2003.

### BACKGROUND

U.S. Pat. No. 4,727,648 (Savage) allegedly cites a “circuit component such as an electrical unit is mounted to a circuit board, by providing a mounting body to support the unit on the board; providing conductive means including contact structure with spring fingers to receive a nit terminal, the conductive means including auxiliary terminal means to project outwardly of the body via a body slot, the contact structure and auxiliary terminal means defining a bridge portion with tab means in the body slot to anchor the body. The light unit may extend at either end of the body.” See Abstract.

U.S. Pat. No. 4,781,960 (Wittes) allegedly cites an “indicator light, preferably a LED, is mounted in a insulating housing secured by a pair of legs with relatively broad feet which are soldered to conductive pads on the surface of a printed circuit board. Preferably, the printed circuit board uses ‘surface mount’ technology. The leads of the LED are spot welded to the legs to make electrical connections between the LED and the circuit board. The structure elevates the LED above the board surface, and/or allows mounting the LED close to the edge of the circuit board, and/or allows the light from the LED to be directed parallel to the board surface. A particularly advantageous use of the structure is one in which printed circuit boards are arranged in an array with the boards parallel to one another and the LED mounting structures near the end of each board so as to provide maximum visibility of the LEDs from many angles so as to quickly indicate equipment functional status to an operator or trouble-shooter. In the manufacturing method, the leg structures are stamped and formed along the edge of a pre-plated and selectively solder-coated strip, with prongs being formed on each leg. The prongs then are pushed into recesses in a plastic body. The LED is inserted and the leads are spot welded to the legs. Then, the assembly is broken off of the strip along a previously formed break-line.” See Abstract.

U.S. Pat. No. 6,386,733 (Ohkohdo) allegedly cites a “light emitting diode mounting structure for a light emitting diode having four leads has two metal plates fixed to wire on a housing. The leads engage the metal plates in electrical contact therewith and are supported by the metal plates, a surface part of which reflects light from the light emitting diode. See Abstract.

U.S. Pat. No. 6,583,542 (Nagano) allegedly cites a “device for mounting a light source according to the present invention is composed of an electric lamp unit (21) having a baseless electric lamp (7) and a base member (8) and a mounting unit (9) having a cavity for receiving the base member of the electric lamp unit (21). The base member (8) is composed of a cylindrical body having a cavity for receiving a lower part of the baseless electric lamp (7) and supporting a pair of lead wires (7a, 7b) led out of the baseless electric lamp (7) on its outer surface. The mounting unit (9) includes a pair of conductive contact members (10a, 10b) on an inner surface of the cavity, which are connected at their lower ends to connection terminals (12a, 12b) on a printed circuit board (12). The electric lamp unit (21) is fitted into the mounting unit (9) in a removable fashion.” See Abstract.

U.S. Pat. No. 4,623,206 (Fuller) allegedly cites “a spring battery retainer that is used to secure a small ‘coin’ or ‘button’ battery to a printed circuit (PC) card or the like. Use of the spring battery retainer provides for positive location of the battery, inexpensive electrical contacts for the battery terminals and positive spring compression that is necessary to insure hard contact with the cathode and the anode terminals of the battery. The battery is easily installed and removed by slightly lifting one end of the battery retainer and sliding the battery in or out. A bend in the spring battery retainer provides sufficient hold-down pressure so that the battery makes reliable contact with an electrical pad located on a PC board. The spring battery retainer is inserted into the PC card and then soldered to it in much the same way as a standard electrical component such as a resistor. The dimensions of the spring battery retainer can be varied so that coin or button batteries of various sizes can be securely fastened to a PC card.” See Abstract.

### SUMMARY

Certain exemplary embodiments comprise a system for mounting an LED. The system can comprise a mounting device and a first bracket coupleable to a surface of the mounting device. The first bracket can be releasably and/or clampably attachable to a first electrically substantially conductive lead of an LED. The first electrically substantially conductive lead can extend substantially in a radial plane of the LED.

### BRIEF DESCRIPTION OF THE DRAWINGS

A wide variety of potential embodiments will be more readily understood through the following detailed description, with reference to the accompanying drawings in which:

FIG. 1 is a perspective view of an exemplary embodiment of a system 1000;

FIG. 2 is a side view of an exemplary embodiment of a system 2000;

FIG. 3 is a perspective view of an exemplary embodiment of a system 3000;

FIG. 4 is a perspective view of an exemplary embodiment of a system 4000;

FIG. 5 is a perspective view of an exemplary embodiment of a system 5000;

FIG. 6 is a perspective view of an exemplary embodiment of a system 6000;

FIG. 7 is a flow diagram of an exemplary embodiment of a method of use 7000 for mounting an LED; and

FIG. 8 is a flow diagram of an exemplary embodiment of a method of use 8000 for replacing an LED.

### DETAILED DESCRIPTION

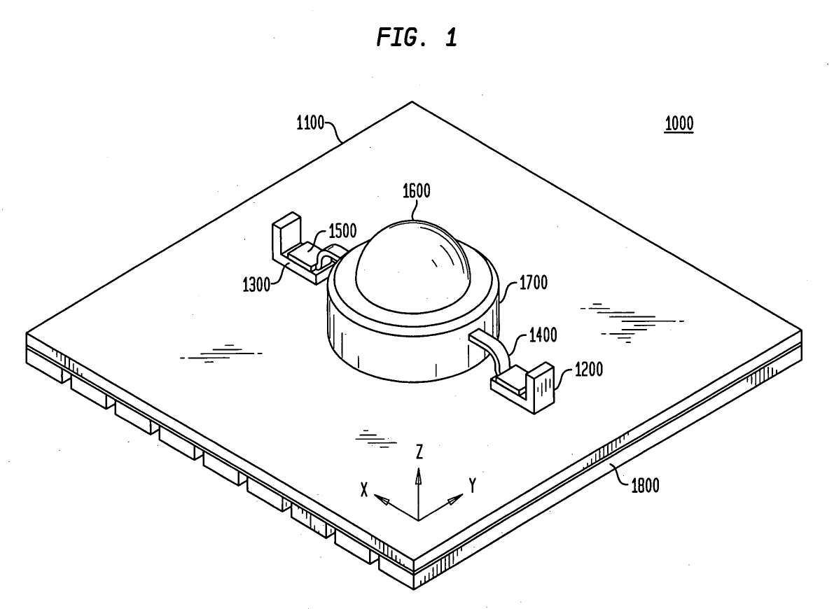

191 FIG. 1 is a perspective view of an exemplary embodiment of a system 1000. An exemplary embodiment of system 1000 can comprise a mounting device 1100. In certain operative embodiments, mounting device 1100 can be a circuit board. Mounting device 1100 can comprise an electrically substantially conductive, electrically substantially partially conductive, and/or electrically substantially non-conductive substrate. Likewise, mounting device 1100 can comprise a thermally substantially conductive, thermally substantially partially conductive, and/or thermally substantially non-conductive substrate. Mounting device 1100 can be connectable to electrical power.

System 1000 can further comprise a first bracket 1200, which can be fixedly attachable to mounting device 1100. In an exemplary embodiment, first bracket 1200 can be attachable to mounting device 1100 via any type of attachment and/or attachment means, such as for example, soldering, surface mount soldering, hand soldering, hot bar soldering, integral manufacture, a threaded fastening system, rivets, hook and loop fastening, electrically conductive tape, glue, electrically conductive epoxy, ultrasonic welding, laser welding, resistance welding, and/or any welding technology, etc. First bracket 1200 can electrically couple an electrically substantially conductive lead 1400 comprised in a Light Emitting Diode (LED) 1600 to mounting device 1100. In certain embodiments, first bracket 1200 can releasably clamp and/or grip lead 1400. In other embodiments, bracket 1200 can be releasably and clampably closable to grip lead 1400. Certain operative embodiments of bracket 1200 can be rotateably closeable. Releasably attaching LED 1600 to mounting device 1100 can allow LED 1600 to be coupled to an electrical circuit and/or voltage source without the risk of damage to LED 1600 during a soldering process. Releasably attaching LED 1600 to mounting device 1100 can also allow for a spent LED 1600 to be replaced.

In certain exemplary embodiments LED 1600 can be supplied for various power supply requirements such as five watts, three watts, and/or one watt, etc. LED 1600 can be adaptable for use in a wide variety of lighting applications, such as for example, traffic signaling devices, outdoor signs, swimming pools, emergency lights, illumination of dark areas, toys, holiday lights, motorized vehicles, airport lights, airplanes, helicopters, air traffic control devices, incandescent light replacement, fluorescent light replacement, halogen light replacement, speakers having flashing colored lights, and/or industrial control applications, etc.

The LED can define a radius about the z-axis as illustrated in FIG. 1. In certain embodiments, lead 1400 can extend substantially radially (e.g., in a plane defined by the x- and y-axes shown in FIG. 1, i.e., in a radial plane of the LED, that is, a plane defined by a radius extending from the LED, that plane substantially perpendicularly intersecting the central (or z-) axis of the LED somewhere between the top of the LED and the bottom of the LED) from an outer circumference (or periphery if the LED is not circular) of LED 1600. In other embodiments, lead 1400 can extend substantially from an outer circumference of LED 1600, such as substantially tangentially to the outer periphery and/or from the outer periphery yet offset from a radius that extends from a central axis of LED 1600. LED 1600 can further comprise a second electrically substantially conductive lead 1500. In certain embodiments, lead 1400 can extend in a substantially opposite direction from lead 1500 wherein both leads are approximately parallel to the x-axis illustrated in FIG. 1. In other embodiments, lead 1400 can be oriented at any angle with respect to lead 1500 including, for example, being parallel to lead 1500, being at an acute angle with respect to lead 1500, being at approximately right angles to lead 1500, and/or being at an obtuse angle with respect to lead 1500, etc.

Lead 1400 and/or lead 1500 can be connectable to a slug 1700. As used herein, the term “slug” means a base assembly connectable and/or integral to LED 1600. Slug 1700 can be manufactured of a thermally substantially conductive material such as aluminum, tin, brass, bronze, and/or copper, which can improve heat dissipation from the LED 1600. Slug 1700 can be manufactured from an electrically substantially conductive material. In certain embodiments, slug 1700 can be positioned in contact with a surface of mounting device 1100. In certain embodiments, slug 1700 can be placed adjacent to, in contact with, or in a spaced relationship to mounting device 1100. When in a spaced relationship to the mounting device 1100, the defined space between slug 1700 and the surface of the mounting device 1100 can be filled with a thermally substantially conductive adhesive. Filling the space with a thermally substantially conductive adhesive can enhance the life of LED 1600 by enhancing the dissipation of heat from LED 1600.

Bracket 1200 can electrically couple and/or releasably attach lead 1400 to mounting device 1100. Likewise, in certain exemplary embodiments, bracket 1300 can electrically couple and/or releasably attach lead 1500 to mounting device 1100. Attaching bracket 1200 to lead 1400 and bracket 1300 to lead 1500 can releasably attach LED 1600 to mounting device 1100. In certain embodiments, bracket 1200 and bracket 1300 can be electrically substantially conductive and electrically connectable to a power source. Bracket 1200 and bracket 1300 can be adaptable to couple power to LED 1600 through lead 1400 and lead 1500. The power source can be further connectable to an electrical resistance, which can be adaptable to limit current flow through LED 1600. Limiting current flow through LED 1600 can reduce heat generated by LED 1600 and can consequently increase the life of LED 1600.

In other embodiments, mounting device 1100 can comprise and/or be connected to a heat dissipator 1800 and/or means for dissipating heat. In certain embodiments, heat dissipator 1800 can be a metallic core sandwiched in mounting device 1100. In other embodiments, heat dissipater 1800 can be a plate attached to mounting device 1100. In other embodiments mounting device 1100 can comprise a cold plate utilizing water for cooling, a thermally conductive metal plate, a heat exchanger comprising fins, a Peltier cooler, and/or a cooling fan. Heat dissipator 1800 can extend the life of an LED by lowering the operating temperature of the LED.

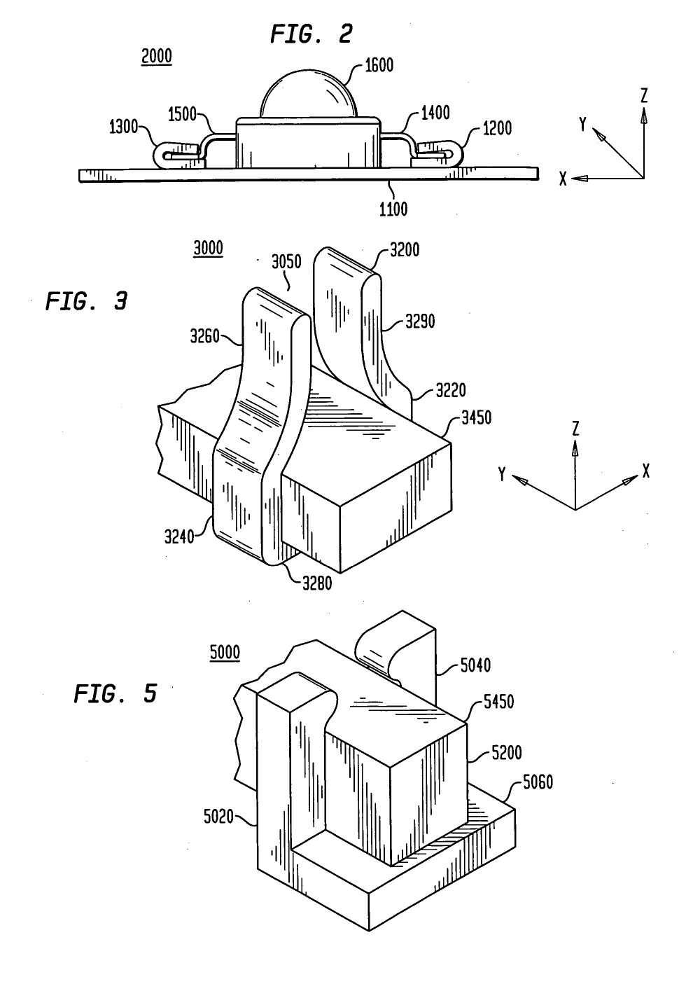

FIG. 2 is a side view of an exemplary embodiment of a system 2000. Bracket 1200 can be rotateably closeable over lead 1400 of LED 1600 to secure lead 1200 to mounting device 1100. Similarly, bracket 1300 can be rotateably closeable over lead 1500 of LED 1600 to secure lead 1500 to mounting device 1100. Rotateably closeable brackets can restrain lead 1400 and lead 1500 from moving in a direction approximately parallel to the x-axis as illustrated in FIG. 2. Securing lead 1400 and lead 1500 can hold LED 1600 in an approximately fixed position.

FIG. 3 is a perspective view of an exemplary embodiment of a system 3000. Certain exemplary embodiments of bracket 3200 can releasably and/or clampably attach to an electrically substantially conductive lead 3450. Bracket 3200 can comprise a pair of lower arms 3220, 3240 and a pair of upper arms 3260, 3290. Bracket 3200 can be adaptable to restrain lead 3450 from motion approximately parallel to the x-axis as illustrated in FIG. 3. Bracket 3200 can further comprise a seat 3280. Seat 3280 can connect arm 3240 to arm 3260. Via friction between first bracket 3200 and lead 3450, any motion of lead 3450 in a direction approximately parallel to the y-axis can be at least partially resisted. Bracket 3200 can further comprise a back (not shown) adaptable to restrain lead 3450 from moving in a direction approximately parallel to the y-axis as illustrated in FIG. 3. In certain operative embodiments seat 3280, lower arms 3220, 3240, and upper arms 3260, 3290 can define a passage 3050. Passage 3050 can provide a volume to hold lead 3450.

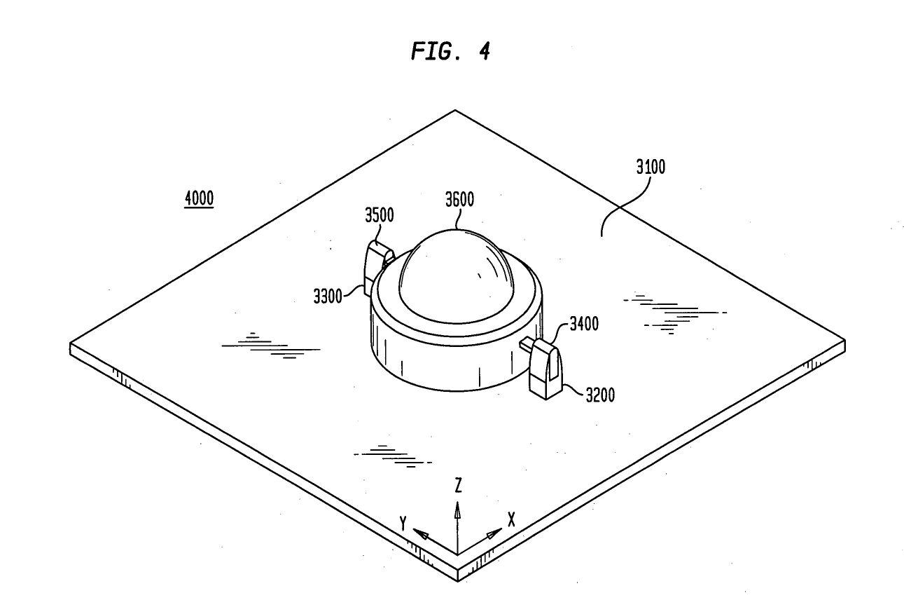

FIG. 4 is a perspective view of an exemplary embodiment of a system 4000. System 4000 can comprise a first bracket 3200 and a second bracket 3300. Brackets 3200, 3300 can be any of a plurality of shapes and configurations adaptable to be fixedly attachable to a mounting device 3100. An LED 3600 can comprise a first electrically substantially conductive lead 3400 and a second electrically substantially conductive lead 3500. Leads 3400, 3500 can be releasably attachable to a mounting device 3100. First bracket 3200 can form a releasable attachment to lead 3400 by snapably attaching to lead 3400. Similarly, second bracket 3300 can form a releasable attachment to lead 3500 by snapably attaching to lead 3500.

FIG. 5 is a perspective view of an exemplary embodiment of a system 5000. A first bracket 5200 can be any one of a plurality of different designs adaptable to be fixedly attachable to a mounting device. Bracket 5200 can comprise a first arm 5020 and a second arm 5040. Bracket 5200 can further comprise a seat 5060. Arms 5020, 5040 can expand from a first position to a second position responsive to an electrically substantially conductive lead 5450 being pressed into bracket 5200. Bracket 5200 can be adaptable to springably return from the second position to approximately the first position as bracket 5200 snapably closes on lead 5450. In certain embodiments, conductive lead 5450 can occupy a passage defined by the arms 5020, 5040 and the seat 5060 of bracket 5200. In other embodiments, bracket 5200 can gripably hold lead 5450 between arms 5020, 5040. In embodiments where bracket 5200 gripably holds lead 5450, arms 5020, 5040 might not fully return to the first position as conductive lead 5450 contacts seat 5060.

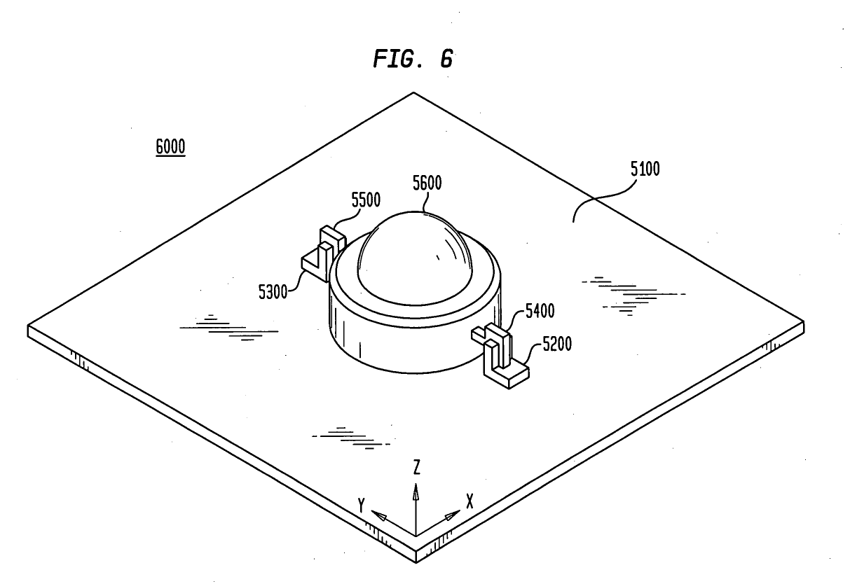

FIG. 6 is a perspective view of an exemplary embodiment of a system 6000. First bracket 5200 can be adaptable to releasably attach an LED 5600 to a mounting device 5100. Certain exemplary embodiments can comprise a first electrically substantially conductive lead 5400 and first bracket 5200. Other exemplary embodiments can comprise a second electrically substantially conductive lead 5500 and a second bracket 5300. Still other exemplary embodiments can comprise a plurality of conductive leads and a plurality of brackets.

Certain exemplary embodiments can comprise bracket 5200 that springably or snapably closes in a manner adaptable to restrain lead 5400. Bracket 5200 can be adaptable to restrain lead 5400 from movement in a direction approximately parallel to the x-axis as illustrated in FIG. 6. In other embodiments, bracket 5200 can be adaptable to restrain lead 5400 from movement in a direction approximately parallel to the y-axis as illustrated in FIG. 6.

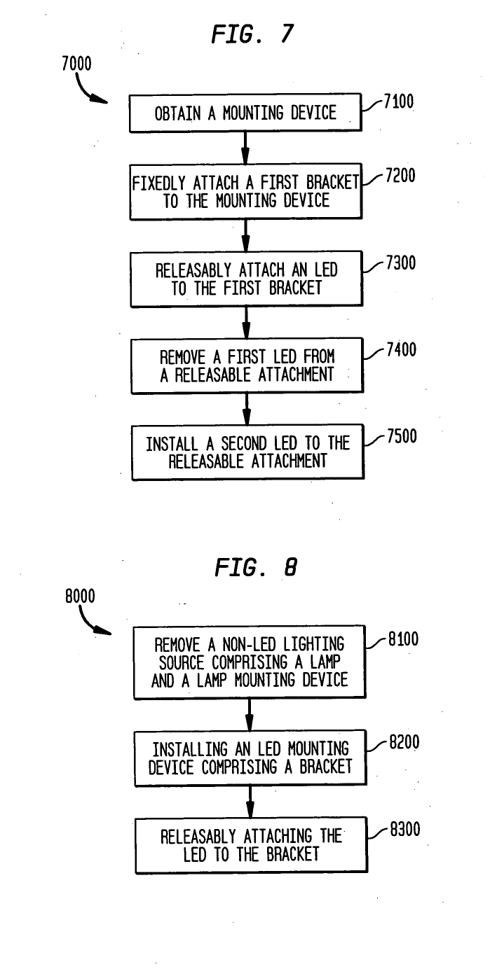

FIG. 7 is a flow diagram of an exemplary embodiment of a method of use 7000 for mounting an LED. At activity 7100, a mounting device can be obtained. The mounting device can be adaptable for the mechanical and electrical coupling of the LED. The mounting device can be a circuit board, the circuit board can further comprise a metallic core.

At activity 7200, a first bracket can be fixedly attached to the mounting device. The first bracket can be fixedly attached using one of a plurality of fastening technologies. The first bracket can be any one of a plurality of possible bracket designs adaptable to releasably attach the first conductive lead of the LED to the mounting device.

At activity 7300, the LED is releasably attached to the first bracket. In certain operative embodiments, the LED is electrically coupled to the mounting device when releasably attached to the first bracket. The LED can be clampably attached, snapably attached, and/or springably attached, etc. In other embodiments, the LED can be releasably attached wherein the first bracket is rotateably closeable.

At activity 7400, a first LED can be removed from a releasable attachment. In certain operative embodiments, the first LED can be removed due to a failure of the LED. In alternative operative embodiments, the first LED can be removed due to a desire to change the properties of the device comprising the LED. The releasable attachment can enhance the ease of changing the LED.

At activity 7500, a second LED can be installed to the releasable attachment. In certain operative embodiments, the second LED can have approximately similar properties to the first LED. In alternative operative embodiments, the second LED can have at least one property substantially different from the first LED. Installing the second LED with at least one property substantially different from the first LED can facilitate a change in luminescence from a device comprising the LED in intensity and/or color.

FIG. 8 is a flow diagram of an exemplary embodiment of a method of use 8000 for retrofitting an LED. At activity 8100 a lamp and a lamp mounting device (such as a socket, holder, base, or the like), comprised in an apparatus using a non-LED lighting source, can be removed from the apparatus. Removing the non-LED lamp and lamp mounting device can allow the apparatus to be retrofitted with an LED. In certain exemplary embodiments, the apparatus can be adaptable for use in traffic signaling and/or regulation.

At activity 8200, an LED mounting device comprising a bracket can be installed in the apparatus. The bracket can be fixedly attachable to the LED mounting device. The bracket can be further adaptable to releasably attach the LED to the mounting device. The LED mounting device can be further adaptable to supply electric power to the LED. In certain exemplary embodiments, electrical power can be transmitted through the bracket and a first electrically substantially conductive lead comprised in the LED.

At activity 8300, the LED can be releasably attached to the bracket. The bracket can provide a means of substantially fixing the LED to a position on the mounted device. The bracket can further provide a means of enhanced heat dissipation from the LED.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, field, background, summary, abstract, drawing figure, etc.) of this application, unless clearly specified to the contrary, there is no requirement for the inclusion in any claim of the application of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render a claim invalid, then any such conflicting information in such incorporated by reference material is specifically not incorporated by reference herein.

1. A system for mounting an LED comprising:
a mounting device; and
a first bracket coupleable to a surface of said mounting device, said first bracket releasably and clampably attachable to a first electrically substantially conductive lead of an LED, the first electrically substantially conductive lead extending substantially in a radial plane of the LED.

2. The system of claim 1, wherein said first bracket is fixedly attachable to said surface of said mounting device.

3. The system of claim 1, wherein said first bracket is integral to said surface of said mounting device.

4. The system of claim 1, wherein the first electrically substantially conductive lead extends from an outer circumference of the LED.

5. The system of claim 1, wherein the first electrically substantially conductive lead extends from an outer periphery of the LED.

6. The system of claim 1, wherein the first electrically substantially conductive lead extends substantially radially from the LED.

7. The system of claim 1, wherein the first electrically substantially conductive lead extends substantially tangentially from the LED.

8. The system of claim 1, wherein the first electrically substantially conductive lead extends from an outer periphery of the LED yet offset from a radius of the LED.

9. The system of claim 1, further comprising the LED.

10. The system of claim 1, further comprising:
a second bracket fixedly attachable to a surface of said mounting device, said second bracket releasably and clampably attachable to a second electrically substantially conductive lead of the LED, the second electrically substantially conductive lead extending substantially radially from an outer periphery of the LED.

11. The system of claim 1, wherein said first bracket is snapably closeable to attach the first electrically substantially conductive lead of the LED to said mounting device.

12. The system of claim 1, wherein said first bracket is rotateably closeable to attach the first electrically substantially conductive lead of the LED to said mounting device.

13. The system of claim 1, wherein said first bracket is springably closeable to attach the first electrically substantially conductive lead of the LED to said mounting device.

14. The system of claim 1, wherein said first bracket is electrically conductive.

15. The system of claim 1, wherein the bracket is solderably connectable to said surface of said mounting device.

16. The system of claim 1, wherein said first bracket is electrically connectable to the first electrically substantially conductive lead of the LED.

17. The system of claim 1, wherein the LED comprises a slug, the slug mountable in contact with a surface of said mounting device.

18. The system of claim 1, wherein the LED comprises a slug, the slug mountable adjacent to a surface of said mounting device.

19. The system of claim 1, wherein the LED comprises a slug, the slug mountable in a spaced relationship to a surface of said mounting device.

20. The system of claim 1, wherein the LED comprises a slug, the slug mountable in a spaced relationship to a surface of said mounting device, a space defined between the slug and said surface of said mounting device adapted to be filled with a thermally conductive adhesive.

21. The system of claim 1, further comprising:
a heat exchanger adapted to dissipate heat from the LED.

22. The system of claim 1, further comprising:
a cold plate heat exchanger adapted to dissipate heat from the LED.

23. The system of claim 1, further comprising:
a finned heat exchanger element adapted to dissipate heat from the LED.

24. The system of claim 1, further comprising:
a Peltier cooler adapted to dissipate heat from the LED.

25. The system of claim 1, further comprising:
a cooling fan adapted to dissipate heat from the LED.

26. The system of claim 1, wherein said mounting device comprises a metal core adapted to dissipate heat from the LED.

27. The system of claim 1, wherein said mounting device comprises an exterior metal plate adapted to dissipate heat from the LED.

28. The system of claim 1, wherein the mounting device comprises an electrical conductor connectable to the first bracket.

29. The system of claim 1, further comprising:
a power supply connectable to said mounting device.

30. The system of claim 1, further comprising:
a resistance adaptable to limit electrical current flowing through the LED.

31. A system for mounting an LED comprising:
a mounting device; and
a means for releasably and clampably attaching a first electrically substantially conductive lead of an LED to said mounting device, the first electrically substantially conductive lead extending in a radial plane of the LED, said means fixedly attachable to a surface of said mounting device.

32. A system for signaling traffic comprising:
a traffic light housing;
a mounting device adapted to couple electrical power to a traffic-managing LED; and
a bracket for releasably and clampably attaching a first electrically substantially conductive lead of the LED to said mounting device, the first electrically substantially conductive lead extending substantially in a radial plane of the LED, said bracket fixedly attachable to a surface of said mounting device.

33. A system comprising:
a lighted device;
a mounting device installable in said lighted device, the mounting device adapted to couple electrical power to an LED; and
a bracket for releasably and clampably attaching a first electrically substantially conductive lead of the LED to said mounting device, the first electrically substantially conductive lead extending substantially in a radial plane of the LED, said bracket fixedly attachable to a surface of said mounting device.

34. A method comprising a plurality of activities comprising:
obtaining a mounting device; and
fixedly attaching a first bracket to a surface of said mounting device, said first bracket releasably and clampably attachable to a first electrically substantially conductive lead of an LED, the first electrically substantially conductive lead extending substantially in a radial plane of the LED.

35. The method of claim 33, further comprising:
releasably attaching the LED to said first bracket.

36. A method of replacing an LED in a lighting device, the method comprising the activities of:
removing a first LED from a releasable attachment comprising a bracket, said first LED comprising an electrically substantially conductive lead extending from an outer periphery of the LED;
installing a second LED to said releasable attachment comprising said bracket, said second LED comprising an electrically substantially conductive lead extending substantially in a radial plane of the LED.

37. A method of replacing a non-LED lighting source with an LED in a lighting device, the method comprising the activities of:
removing a non-LED lighting source comprising a lamp and a lamp mounting device;
installing an LED mounting device comprising a bracket fixedly attached to the LED mounting device, said bracket releasably and clampably attachable to an electrically substantially conductive lead of an LED, the electrically substantially conductive lead extending substantially in a radial plane of the LED.

38. The method of claim 37, further comprising:
releasably attaching the LED to said bracket.
